(19) United States
(12) Patent Application Publication
(10) Pub. No.: US 2001/0043445 A1
(43) Pub. Date: Nov. 22, 2001

(54) Thin film magnetic head with tip sub-magnetic pole and method of manufacturing the same

(75) Inventors: Syuji Nishida, Kawasaki (JP); Ikuya Tagawa, Kawasaki (JP); Tomoko Kutsuzawa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 09/803,584

(22) Filed: Mar. 9, 2001

Related U.S. Application Data
(63) Continuation of application No. PCT/JP99/01745, filed on Apr. 2, 1999.

(30) Foreign Application Priority Data
Sep. 18, 1998 (JP) 10-264727

(51) Int. Cl. G11B 5/39; G11B 5/127

(52) U.S. Cl. 360/317; 360/126; 29/603.14

(57) ABSTRACT

A thin film magnetic head includes: a lower magnetic pole (8); an upper magnetic pole (16) disposed to face the lower magnetic pole; a recording coil disposed between the lower magnetic pole and the upper magnetic pole, the recording coil being spaced from the both magnetic poles; and an upper tip sub-magnetic pole (22) provided at the side of the lower magnetic pole of the upper magnetic pole in the vicinity of a floating surface (ABS). In the first aspect, the upper magnetic pole and the upper tip sub-magnetic pole are disposed in such a manner that an end portion at the side of the floating surface of the upper magnetic pole recedes from an end portion at the side of the floating surface of the upper tip sub-magnetic pole. In the second aspect, a portion of the upper magnetic pole in the vicinity of the floating surface is formed to be narrower than the other portion of the pole, and to be wider than a core width of the upper tip sub-magnetic pole. Moreover, both corner portions at the lower magnetic pole side of the pole of the upper magnetic pole are chamfered and formed in a tapered shape. According to the thin film magnetic head having such a structure, a sub peak which is not preferable in a recording magnetic field can be substantially eliminated, and it is possible to realize an improvement in a recording blur characteristic and a good overwrite characteristic.

### TECHNICAL FIELD

The present invention relates to a thin film magnetic head for use in a magnetic disk drive, a magnetic tape apparatus or the like, more specifically to a thin film magnetic head with a tip sub-magnetic pole having a unique shape, and a method of manufacturing the same.

### BACKGROUND ART

As magnetic heads for use in a magnetic disk drive, a magnetic tape apparatus or the like, there are known an inductive recording/reproducing thin film head, a complex magnetic head using an inductive recording head and a reproducing head using a magnetoresistance effect element, or the like.

FIG. 1 is a view showing a constitution of a typical complex magnetic head with a portion thereof being cut out. In order to make it easy to see the inside of the magnetic head, illustration for a protective layer of the uppermost layer is omitted, and with regard to a recording head WR, the right half thereof is removed.

The illustrated complex magnetic head comprises: a semiconductor substrate (wafer) 1; a substrate protective film 2 formed on this substrate 1; a reproducing head RE formed on the substrate protective film 2; the recording head WR formed on the reproducing head RE; and the protective layer 17 (not shown) formed on the recording head WR.

The reproducing head RE includes: a lower magnetic shield layer 3; a first non-magnetic insulating layer (lower gap layer) formed on the lower magnetic shield layer 3; a magnetic transducer 5 formed on the first non-magnetic insulating layer 4; a pair of terminals 6 (only one terminal being shown in the illustrated example) formed at both ends of the magnetic transducer 5; a second non-magnetic insulating layer (upper gap layer) 7 formed on the magnetic transducer 5 and the pair of terminals 6; and an upper magnetic shield layer 8 formed on the second non-magnetic insulating layer. The upper magnetic shield layer 8 is combined with a lower magnetic pole of the recording head WR.

The recording head WR includes: the lower magnetic pole 8; a recording gap layer 9; a spiral recording coil 12 disposed on the recording gap layer 9; third and fourth non-magnetic insulating layers 10 and 11 covering the recording coil 12; and an upper magnetic pole 16 formed on the non-magnetic insulating layers 10 and 11. Note that the recording coil does not exist in a center region 13 of the spiral recording coil 12, and the upper magnetic pole 16 dents in the center region 13 to be connected to the lower magnetic pole 8. In addition, the upper magnetic pole 16 tapers toward a recording medium 20, and this portion is particularly called a pole 16a of the upper magnetic pole.

As described above, the complex magnetic head shown in FIG. 1 has a piggyback structure in which the recording head WR is added to a back of the reproducing head RE. Note that, in order to clarify a positional relation among the respective elements of the magnetic head, as shown in the drawing, the direction of a floating surface of the upper magnetic pole 16 is defined as an X direction, the depth direction of the magnetic head when viewed from the floating surface is defined as a Y direction, and the laminating direction of the magnetic head is defined as a Z direction.

Moreover, as the magnetic transducer 5 of the reproducing head RE, for example, an anisotropic magnetoresistance effect element (MR element), typically, a giant magnetoresistance effect element (GMR element) such as a spin-valve magnetoresistance effect element or the like can be used. To both ends of the magnetic transducer 5, the pair of terminals 6 are connected, and during a reading operation, a constant sense current is flown through the terminals 6 to the magnetic transducer 5.

As described above, the complex magnetic head faces the recording medium 20 such as a magnetic disk separately by a slight distance (flying amount) to be positioned, reads out magnetically recorded information recorded in the recording medium 20 by the reproducing head RE, and magnetically writes information to the recording medium 20 by the recording head WR, while moving relatively to the recording medium 20 along a track longitudinal direction (bit length direction).

FIG. 2A and FIG. 2B are views explaining the recording head WR in the complex magnetic head of FIG. 1 in more detail.

As shown in FIG. 2B, the recording head has a structure in which the two magnetic poles (lower magnetic pole 8 and upper magnetic pole 16) face each other by interposing the small recording gap layer 9. The lower magnetic pole 8 is called a leading side magnetic pole because it becomes a magnetic pole encountering a track on the recording medium 20 for the first time from the running direction of the recording medium 20, and on the other hand, the upper magnetic pole 16 is called a trailing side magnetic pole because it becomes a magnetic pole in a direction where the track on the recording medium 20 fades away. Between the lower magnetic pole 8 and the upper magnetic pole 16, there exists a spiral recording coil 12 surrounded by the non-magnetic insulating layers 10 and 11.

In the recording head WR, when current is flown to the recording coil 12, the upper magnetic pole 16 and the lower magnetic pole 8 are magnetized, a recording magnetic field (leakage magnetic field) for writing to the recording medium 20 is generated at a pole 16a side of the upper magnetic pole 16 and a floating surface (ABS: Air Bearing Surface) side of the lower magnetic pole 8, which are on both sides of the recording gap layer 9. In the recording head WR, the recording medium 20 is magnetized by this leakage magnetic field, and information recording is performed.

It is conceived that a magnetic field intensity H, the magnetic field being applied to the recording medium 20, is appropriate at about twice a medium coercive force Hc, and since the coercive force Hc of a recent recording medium is nearly 3000 [Oe: oersted], it is desirable that the magnetic field intensity H during recording be about 6000 [Oe].

Moreover, the magnetic field intensity H of a lower limit where a reverse of magnetization occurs in the recording medium 20 is generally conceived to be about ½ (namely, 1500 [Oe]) of the medium coercive force Hc. Accordingly, when there exists a magnetic field exceeding ½ of the medium coercive force Hc outside a range of the track to be recorded thereon, reverse of magnetization (recording blur) is generated in a track adjacent to the track concerned, and the reverse of magnetization (recording demagnetization) at a trailing side in the head running direction occurs, thus bringing a barrier for high recording densification of the recording medium.

In order to realize the high recording densification, usually, it is necessary to increase a track density. For this purpose, it is necessary to narrow a width of the recording magnetic field to be generated by narrowing a core width at an end portion of the pole 16a of the upper magnetic pole and a core width at an end portion of the lower magnetic pole 8. In the above-described complex magnetic head, since the lower magnetic pole 8 of the recording head WR is combined with the upper magnetic shield layer 8 of the reproducing head RE, there is a certain limitation on a shape of the complex magnetic head from the viewpoint of securing a function of the magnetic shield. Specifically, the lower magnetic pole 8 has been formed to have a core width considerably wider than the core width of the upper magnetic pole 16 from the need of sharing the function of the magnetic shield therewith. For this reason, the recording magnetic field formed between both of the magnetic poles 8 and 16 has been distributed widely in the track width direction, and it has been difficult to narrow a track pitch of the recording medium 20 in the wide recording magnetic field.

As an example of the art to cope with this, for example, the art disclosed in the gazette of Japanese Patent Laid-Open No. 7-225917 (corresponding U.S. patent application Ser. No. 192,680) is known. In this art, a lower magnetic pole end element and an upper magnetic pole end element (each magnetic pole end element is also referred to as a “tip sub-magnetic pole”), each of which has a narrow core width, are additionally formed for the lower magnetic pole 8 and the upper magnetic pole 16, respectively, thus reducing the recording blur in the core width direction.

FIG. 3A and FIG. 3B show a constitution of a thin film magnetic head with the tip sub-magnetic poles according to the prior art. FIG. 3A is a view corresponding to FIG. 2B, and FIG. 3B is a view of the respective magnetic pole sides viewed from the floating surface ABS. As shown in FIG. 3A, the lower magnetic end element (lower tip sub-magnetic pole) 21 is formed at the upper magnetic pole 16 side of the lower magnetic pole 8 in the vicinity of the floating surface ABS, and the upper magnetic pole end element (upper tip sub-magnetic pole) is formed at the lower magnetic pole 8 side of the upper magnetic pole 16 in the vicinity of the floating surface ABS.

In the prior art, as shown in the drawings, the structure in which the respective tip sub-magnetic poles 21 and 22 are formed to be rectangular is only shown. Shapes and arrangement positions of the respective tip sub-magnetic poles, alternatively, performance and characteristic of the thin film magnetic head are not discussed at all.

In the thin film magnetic head with such tip sub-magnetic poles, the tip sub-magnetic poles 21 and 22 are respectively provided on the lower magnetic pole 8 and the upper magnetic pole 16, and the core widths are regulated to be substantially narrow by the respective tip sub-magnetic poles, and thus the recording magnetic field can be generated through the recording gap layer 9 between the tip sub-magnetic poles having the narrow core widths.

The present inventors consider that provision of the tip sub-magnetic poles in the thin film magnetic head is a promising art in the following points (1) and (2), in addition to the above-described advantage.

(1) As an art of narrowing a core width, the provision art is excellent in a point that a precise dimensional accuracy is obtained. However, under the current circumstances, by formation of the pole of the upper magnetic pole utilizing other process technologies, for example, ion milling, an art using a focused ion beam (FIB) or the like, the tip portion of the upper magnetic pole cannot be formed with a dimensional accuracy in the sub-micron order.

(2) According to a desire, a material of the tip sub-magnetic pole can be made different between the upper magnetic pole and the lower magnetic pole.

However, as described above, in the art disclosed in the gazette of Japanese Patent Laid-Open No. 7-225917, with regard to the characteristic of the thin film magnetic head with such a tip sub-magnetic pole, neither evaluation nor discussion is given.

On the other hand, the present applicant previously proposed an art of narrowing a core width by the approach other than the provision of the tip sub-magnetic pole (in Japanese Patent Application No. 10-184780 filed on Jun. 30, 1998, but not laid-open at the time of the filing of the present application or publicly known). FIG. 4A and FIG. 4B are views briefly explaining the proposed art. In the art, as shown in FIG. 4B, trimming with the focused ion beam (FIB) is executed for both ends of the pole 16a of the upper magnetic pole 16, thus narrowing the core width thereof. Note that the trimming with the FIB will be hereinafter simply referred to as “FIB trimming”.

In the proposed art, with regard to the thin film magnetic head in which the core width of the upper magnetic pole is narrowed by the FIB trimming, a discussion on the characteristic of the head is not given.

Therefore, the present inventors performed evaluation for the characteristic of the head in order to evaluate the thin film magnetic head with the tip sub-magnetic pole, which is conceived to be technically promising.

FIG. 5A to FIG. 5C are views for explaining the shape of the tip portion of the thin film magnetic head with the tip sub-magnetic pole. As shown in FIG. 5A, the lower magnetic pole 8 is combined with the upper magnetic shield layer of the reproducing head RE as described in association with FIG. 1, and thus the floating surface (ABS) has a relatively large end surface (core width) due to the limitation of the shape thereof. Contrary to this, the upper magnetic pole 16 copes with a high track density of the recording medium, and thus the floating surface has a relatively small end surface (core width). As shown in FIG. 5B, the lower tip sub-magnetic pole 21 is formed at the side of the upper magnetic pole of the lower magnetic pole 8 in the vicinity of the floating surface, and the upper tip sub-magnetic pole 22 is formed at the side of the lower magnetic pole of the upper magnetic pole 16 in the vicinity of the floating surface. The recording gap layer 9 is formed between the lower tip sub-magnetic pole 21 and the upper tip sub-magnetic pole 22. As shown in FIG. 5B and FIG. 5C, the lower tip sub-magnetic pole 21 and the upper tip sub-magnetic pole 22 have the same rectangular shape.

Herein, in order to specify the shapes or the like of the upper magnetic pole 16 and the upper tip sub-magnetic pole 22, the following are defined.

Sw: core width of the upper tip sub-magnetic pole 22 (see FIG. 5A to FIG. 5C)

Pw: core width of the upper magnetic pole 16 (see FIG. 5A and FIG. 5C)

Gd: depth of the recording gap layer 9 (see FIG. 5A and FIG. 5B)

SL: length of the upper tip sub-magnetic pole 22 (see FIG. 5B and 5C)

FIG. 6 shows a model of the tip portion of the thin film magnetic head with the tip sub-magnetic pole as an evaluation object, and is a view of the upper magnetic pole 16, the upper tip sub-magnetic pole 22, the lower tip sub-magnetic pole 21 and the lower magnetic pole 8, which are perspectively viewed from the floating surface (ABS) side.

In the drawing, the lower magnetic pole 8 is shown at the right side, and facing the lower magnetic pole 8, the upper magnetic pole 16 is shown at the left side. Moreover, the lower tip sub-magnetic pole 21 is shown at the side of the upper magnetic pole of the lower magnetic pole 8, and the upper tip sub-magnetic pole 22 is shown at the side of the lower magnetic pole of the upper magnetic pole 16. There is a predetermined gap between the upper tip sub-magnetic pole 22 and the lower tip sub-magnetic pole 21, and in this gap, the recording gap layer 9 (not shown) is disposed. With these elements constituting the thin film magnetic head, X-X′ denotes a centerline in an X direction. Since the upper magnetic pole 16, the upper tip sub-magnetic pole 22, the lower tip sub-magnetic pole 21 and the lower magnetic pole 8 are plane-symmetrical with respect to a Y-Z plane passing through the X-direction centerline X-X′, only a lower half thereof is shown in the drawing, and illustration of an upper half thereof is partially omitted. Specifically, illustration of an upper half of the lower magnetic pole 8 is omitted.

Next, description will be made for the surfaces in which the recording magnetic fields emitted from these constituent components are evaluated. If A-A′ is defined as a line specifying a magnetic field calculation position, the line A-A′ is on a line where an X-Y plane passing through center of the upper tip sub-magnetic pole 22 and the lower tip sub-magnetic pole 21 and an X-Z plane in which the recording medium (not shown) is located slightly separate from the respective constituent components to a minus (−) side in the Y direction cross each other, and a start point A is on an intermediate between the upper tip sub-magnetic pole 22 and the lower tip sub-magnetic pole 21 (on a position corresponding to the X-direction centerline X-X′). The reason why the start point A is defined at this point is that, since the magnetic head is plane-symmetrical with respect to the Y-Z plane passing through the X-direction centerline X-X′, the magnetic fields emitted from the respective constituent components are also similarly plane-symmetrical. The line A-A′ extends from the start point A to an A′ direction in correspondence with the center of the upper tip sub-magnetic pole 22 and the lower tip sub-magnetic pole 21. Accordingly, the line A-A′ will be referred to as a “gap centerline”.

The line B-B′ is on the line where the X-Y plane including a boundary surface of the upper magnetic pole 16 and the upper tip sub-magnetic pole 22 and the X-Z plane in which the recording medium (not shown) is located cross each other, a start point B is on an intermediate of the upper tip sub-magnetic pole 22 (on a position corresponding to the X-direction centerline X-X′). The line B-B′ extends from the start point B to a B′ direction in correspondence with the boundary surface of the upper magnetic pole 16 and the upper tip sub-magnetic pole 22.

The line A-A′ specifying the magnetic field calculation position is one for evaluating the recording magnetic field (received by the recording medium) at the intermediate position of the upper tip sub-magnetic pole 22 and the lower tip sub-magnetic pole 21. Accordingly, the highest peak value of the magnetic field is expected at this position. On the other hand, the line B-B′ is one for evaluating an influence of the upper magnetic pole 16 on the recording medium in the case where the upper tip sub-magnetic pole 22 is provided.

Therefore, as a surface which includes the line A-A′ and the line B-B′ and is capable of sufficiently evaluating a tendency of the recording magnetic fields emitted from the respective constituent components, the recording magnetic field evaluating surface 40 as shown in FIG. 6 is preset. The recording magnetic field evaluating surface 40 is a rectangular surface surrounded by a point A (x=0, Z=0), a point 40a (x=0, z=full scale), a point 40b (x=full scale, z=full scale), a point 40c (x=full scale, z=−full scale) and a point 40d (x=0, z=−full scale), and is located on the surface of the recording medium (not shown).

FIG. 7 shows a distribution of the recording magnetic field in the recording magnetic field evaluating surface 40, namely, an evaluation result of the recording magnetic field. The evaluation is based on a result obtained by performing a computer simulation using three-dimensional magnetic field analysis software. Note that, as the three-dimensional magnetic field analysis software, the magnetic field analysis software named “MAGIC”, which is commercially available from ELF Corporation located in Japan, is utilized.

The spot where the magnetic field intensity is largest in a range of the recording magnetic field evaluating surface 40 is the start point A on the line A-A′. As described above, this position corresponds to the intermediate of the two tip sub-magnetic poles 21 and 22, is a spot where writing is performed for the recording medium, and exhibits a “main peak” of the magnetic field intensity.

It is appreciated that a spot where the magnetic field intensity is second largest exists in the spot corresponding to the boundary of the upper magnetic pole 16 and the tip sub-magnetic pole 22 (in the center portion on the line B-B′ in the drawing). This is referred to as a “sub peak” of the magnetic field intensity. As described above, it proved that the sub peak other than the main peak existed for the first time by this evaluation. As for magnetic materials, it is known that a magnetic charge is converged on a sharp tip, and from the position of this sub peak, it is judged that the upper magnetic pole edge 16c shown in FIG. 6 is the cause of generation of the sub peak. From this, the line B-B′ will be referred to as a “upper magnetic pole edge position line”.

FIG. 8 is a graph showing a distribution of the recording magnetic field along the line A-A′ (which is the gap centerline and includes the main peak) and the line B-B′ (which is the upper magnetic pole edge position line and includes the sub peak) in the recording magnetic field evaluating surface 40, namely, an evaluation result of the recording magnetic field. The abscissa thereof represents a distance from the start points A and B in the track width direction (X direction), and in the illustrated example, corresponds to x=0 to 1.4 μm, namely, to x=0 to full scale in the recording magnetic field evaluating surface 40.

From FIG. 8, it proved that there were two problems in that the intensity Hx of the recording magnetic field along the line B-B′ was a value near or equal to 1500 [Oe] or more and that a value relation between the intensity Hx of the recording magnetic field along the line B-B′ and the intensity Hx of the recording magnetic field along the line A-A′ was reversed in a range of: x=0.9 to 1.2 μm (range corresponding to the sub peak).

Namely, the position where the sub peak exists is out of the range of the track to be recorded thereon, and in addition, since the intensity Hx of the recording magnetic field along the line B-B′, which includes this sub peak, exceeds ½ of a medium coercive force Hc (namely, 1500 [Oe]), as described above, the reverse of magnetization (recording blur) has been generated in a track adjacent to the track concerned to be recorded thereon, and the reverse of magnetization (recording demagnetization) at the trailing side in the head running direction has occurred, thus bringing a barrier of high recording densification of the recording medium.

### DISCLOSURE OF THE INVENTION

In consideration of the problems in the above-described prior art, the object of the present invention is to substantially eliminate a sub peak which is not preferable in a recording magnetic field, to achieve an improvement in a recording blur characteristic and to realize a good overwrite characteristic, and to provide a novel thin film magnetic head with a tip sub-magnetic pole capable of contributing to a high recording densification, and a method of manufacturing the same.

To achieve the foregoing objects, according to a first aspect of the present invention, there is provided a thin film recording head comprising: a lower magnetic pole; an upper magnetic pole disposed to face the lower magnetic pole; a recording coil disposed between the lower magnetic pole and the upper magnetic pole, the recording coil being spaced from the both magnetic poles; and an upper tip sub-magnetic pole provided at the side of the lower magnetic pole of the upper magnetic pole in the vicinity of a floating surface, in which the upper magnetic pole and the upper tip sub-magnetic pole are disposed in such a manner that an end portion at the side of the floating surface of the upper magnetic pole recedes from an end portion at the side of the floating surface of the upper tip sub-magnetic pole.

Moreover, according to a second aspect of the present invention, there is provided a thin film magnetic head comprising: a lower magnetic pole; an upper magnetic pole disposed to face the lower magnetic pole; a recording coil disposed between the lower magnetic pole and the upper magnetic pole, the recording coil being spaced from the both magnetic poles; and an upper tip sub-magnetic pole provided at the side of the lower magnetic pole of the upper magnetic pole in the vicinity of a floating surface side, in which the upper magnetic pole is formed in such a manner that a portion of a pole thereof in the vicinity of the floating surface is narrower than the other portion of the pole, and is wider than a core width of the upper tip sub-magnetic pole.

Furthermore, according to a preferred embodiment of the present invention, in the thin film magnetic head in accordance with the above-described first or second aspect, the upper magnetic pole is formed in a tapered shape in such a manner that both corner portions at the side of the lower magnetic pole of a pole thereof are chamfered.

Still further, according to the present invention, there is provided a complex magnetic head comprising: a recording head using the thin film magnetic head in accordance with the above-described first or second aspect;

and a reproducing head using a magnetoresistance effect element as a magnetic transducer, in which the recording head and the reproducing head are integrally formed.

Yet further, according to a third aspect of the present invention, there is provided a method of manufacturing a thin film magnetic head, comprising the steps of: forming a lower magnetic pole; patterning a first resist in a predetermined shape on the lower magnetic pole, so as to form an upper tip sub-magnetic pole in accordance with the shape of the first resist; partially trimming the lower magnetic pole, after removing the first resist, so as to form a lower tip sub-magnetic pole; forming an alumina layer on a trimmed portion of the lower magnetic pole and the upper tip sub-magnetic pole; polishing and flattening surfaces of the alumina layer and the upper tip sub-magnetic pole in a film thickness direction; forming a recording coil with a periphery surrounded by non-magnetic insulating layers on the flattened alumina layer; patterning a second resist in a predetermined shape on the flattened upper tip sub-magnetic pole, so as to form an upper magnetic pole in accordance with the shape of the second resist; and cutting out a thin film magnetic head from a wafer, after removing the second resist, so as to mechanically polish the head to a final finish line.

### BRIEF DESCRIPTION OF THE DRAWINGS

FIG. 1 is a perspective view showing a typical complex magnetic head with a portion thereof cut out;

FIG. 2A and FIG. 2B are views for explaining in detail a recording head in the complex magnetic head of FIG. 1 ;

FIG. 3A and FIG. 3B are views showing a constitution of a prior art thin film magnetic head with a tip sub-magnetic pole;

FIG. 4A and FIG. 4B are views showing a constitution of a thin film magnetic head in which a core width is narrowed by FIB trimming, previously proposed by the present applicant;

FIG. 5A to FIG. 5C are views for explaining a shape of a tip portion of the thin film magnetic head with a tip sub-magnetic pole;

FIG. 6 is a view showing a tip portion model of the thin film magnetic head with a tip sub-magnetic pole to be evaluated;

FIG. 7 is a diagram showing a distribution of a recording magnetic field (evaluation result of the recording magnetic field) in the recording magnetic field evaluating surface of FIG. 6;

FIG. 8 is a graph showing distributions of the recording magnetic fields (evaluation result of the recording magnetic field) along a line A-A′ and a line B-B′ in the recording magnetic field evaluating surface of FIG. 6;

FIG. 9A to FIG. 9D are views showing a constitution of the thin film magnetic head with a tip sub-magnetic pole according to a first embodiment of the present invention;

FIG. 10 is a graph showing evaluation results of main peaks and sub peaks of the recording magnetic field Hx with regard to the thin film magnetic head of the first embodiment when the receding height SH is varied;

FIG. 11 is a graph showing evaluation results of main peaks and sub peaks of the recording magnetic field Hx with regard to the thin film magnetic head of the first embodiment when the ratio (SL/SH) of the tip sub-magnetic pole length SL to the receding height SH is varied;

FIG. 12A to FIG. 12D are views showing a constitution of the thin film magnetic head with a tip sub-magnetic pole according to a second embodiment of the present invention;

FIG. 13A to FIG. 13C are graphs showing evaluation results of the recording magnetic field Hx with regard to the thin film magnetic head of the second embodiment when the core width difference ΔPw is varied;

FIG. 14A to FIG. 14D are views showing a constitution of the thin film magnetic head with a tip sub-magnetic pole according to a third embodiment of the present invention;

FIG. 15A to FIG. 15C are graphs showing evaluation results of the recording magnetic field Hx with regard to the thin film magnetic head of the third embodiment when the upper magnetic pole edge angle θ is varied;

FIG. 16A to FIG. 16H are a flowchart showing a method of manufacturing the thin film magnetic head according to the first embodiment in accordance with the order of process;

FIG. 17A to FIG. 17D are views showing a manufacturing process in the case where trimming by ion milling is performed for a wafer surface;

FIG. 18A to FIG. 18C are views showing a manufacturing process in the case where FIB trimming is performed for the wafer surface;

FIG. 19A and FIG. 19B are views showing a manufacturing process in the case where the trimming by ion milling is performed for a floating surface; and

FIG. 20A and FIG. 20B are views showing a manufacturing process in the case where the FIB trimming is performed for the floating surface.

### BEST MODE FOR CARRYING OUT THE INVENTION

Hereinbelow, description will be made in detail for the thin film magnetic head and a method of manufacturing the same according to the present invention by way of concrete embodiments with reference to the accompanying drawings. Note that like reference numerals are added to like constituent components throughout the respective drawings, and thus repetition of the description is omitted.

\mathring{1} Thin Film Magnetic Head

The present inventors reviewed whether the existence of a sub peak can be substantially eliminated, whether a recording blur characteristic can be improved, and whether a magnetic field intensity required for a good overwrite characteristic can be obtained, by optimizing shapes, forming positions or the like of an upper magnetic pole and an upper tip sub-magnetic pole of the thin film magnetic head.

In this regard, the present inventors decided to consider the following points (a), (b) and (c) with regard to the shapes, the positional relations or the like of the upper magnetic pole and the upper tip sub-magnetic pole of the thin film magnetic head. These points (a), (b) and (c) correspond respectively to first, second and third embodiments of the present invention as described later.

(a) Reducing an influence of a magnetic charge converged on the upper magnetic pole edge 16c by moving the upper magnetic pole edge 16c away from the recording medium 20.

(b) In addition to adoption of the upper tip sub-magnetic pole, jointly using trimming for the pole 16a of the upper magnetic pole 16, which has been proposed by the present inventor in the above-described Japanese Patent Application No. 10-184780.

(c) Reducing the magnetic field intensity of the sub peak by chamfering a sharp portion of the upper magnetic pole edge 16c.

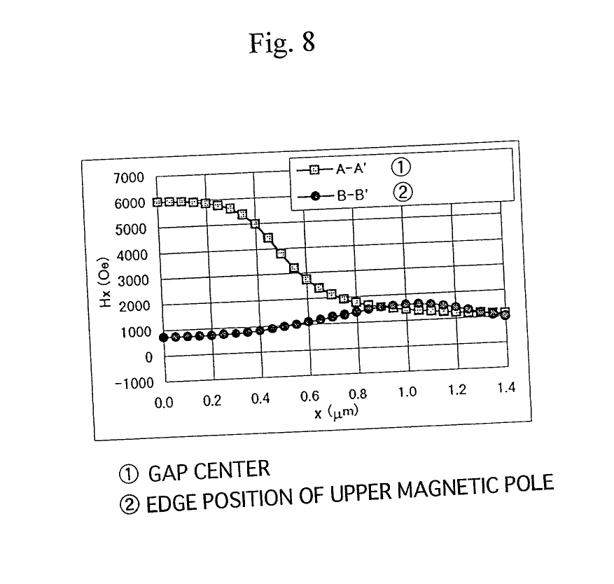

Moreover, criterion of the judgment for the presence of an improvement effect is set as follows, in comparison with the evaluation result described in association with FIG. 8.

(1) When the recording magnetic field intensity for a track to be recorded thereon, namely, the magnetic field intensity Hx of the main peak along the line A-A′ is a value near or equal to 6000 [Oe] or more in the vicinity of a gap center (z=0), it is judged that the improvement effect is present.

(2) When the recording magnetic field intensity for a track other than the track to be recorded thereon, namely, the magnetic field intensity Hx of the sub peak along the line B-B′ is a value equal to 1500 [Oe] or less, it is judged that the improvement effect is present.

(3) When the value relation of the recording magnetic field intensity along the line B-B′ and the recording magnetic field intensity along the line A-A′ is not reversed, it is judged that the improvement effect is present.

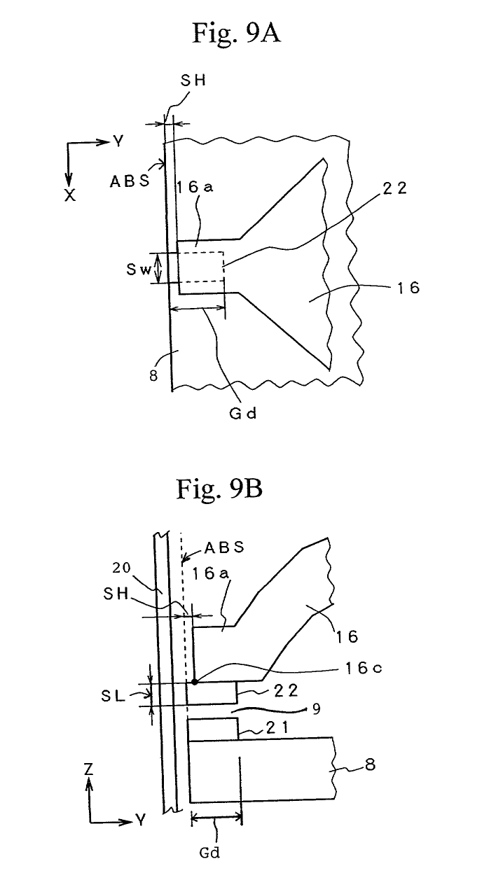

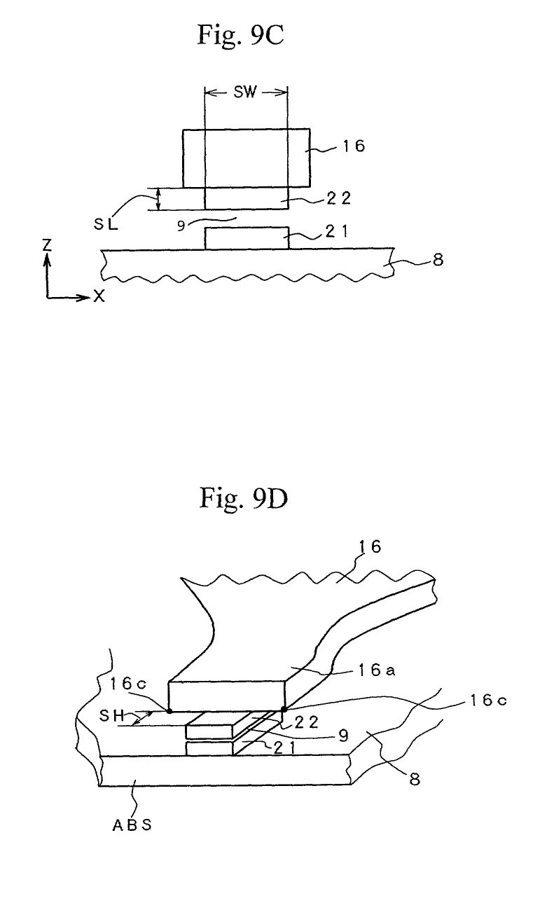

FIG. 9A to FIG. 9D show a constitution of the thin film magnetic head with a tip sub-magnetic pole according to the first embodiment of the present invention. Specifically, FIG. 9A shows a plane structure of the vicinity of the magnetic pole tip of the recording head in the thin film magnetic head when viewed from the upper surface (wafer surface) of the substrate, FIG. 9B shows a sectional structure of the vicinity of the magnetic pole tip, FIG. 9C shows a structure of the magnetic pole tip portion when viewed from the floating surface ABS, and FIG. 9D shows a structure of the vicinity of the magnetic pole tip when viewed perspectively. Note that the floating surface ABS is defined as a magnetic pole tip surface which faces the recording medium 20.

In this embodiment, evaluation was performed with regard to moving the upper magnetic pole edge 16c away from the recording medium 20 in order to reduce the influence by a magnetic charge converged on the upper magnetic pole edge 16c.

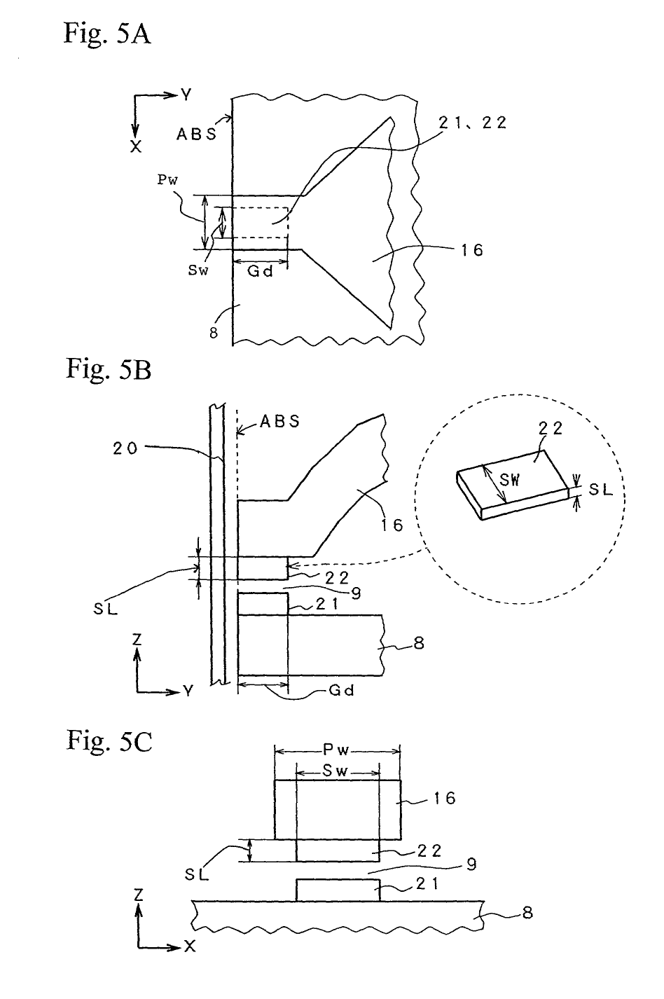

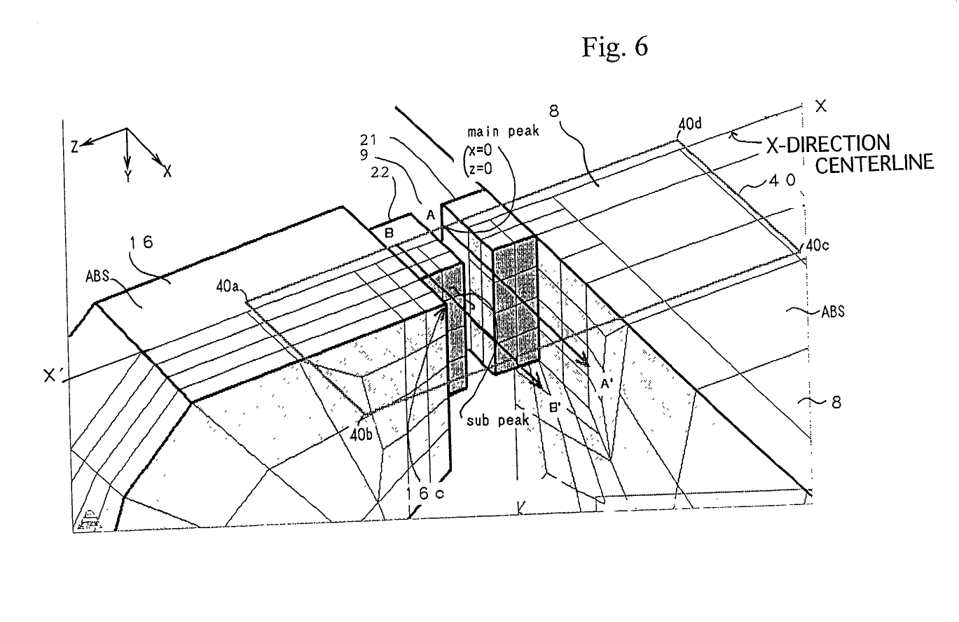

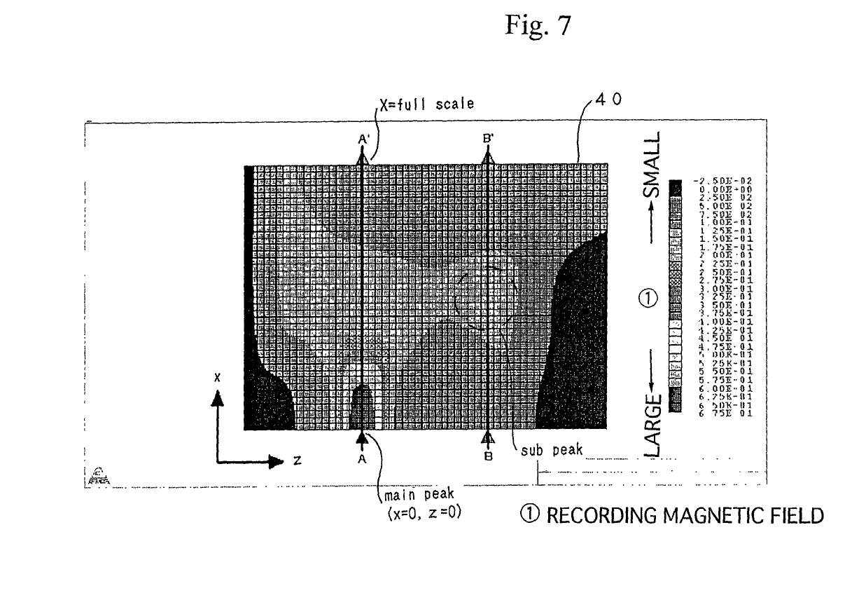

As described above in association with FIG. 5B, in the conventional thin film magnetic head with a tip sub-magnetic pole, the end portion at the side of the floating surface ABS of the upper magnetic pole 16 and the end portion at the side of the floating surface ABS of the upper tip sub-magnetic pole 22 exist in the same plane.

Contrary to this, in the present embodiment, as shown in FIG. 9B and FIG. 9D, both of the end portions exist in planes different from each other. Specifically, the end portion at the side of the floating surface ABS of the upper magnetic pole 16 (pole 16a) is pulled back in a direction where it fades away from the floating surface ABS, and a specified distance SH with the end portion at the side of the floating surface ABS of the upper tip sub-magnetic pole 22 is provided. The SH will be defined as a “receding height” of the upper magnetic pole 16 from the floating surface ABS hereinbelow.

Note that the constitution of the thin film magnetic head according to this embodiment is basically the same as the constitution of the thin film magnetic head shown in FIG. 5A to FIG. 5C, except that the receding height SH is provided as described above.

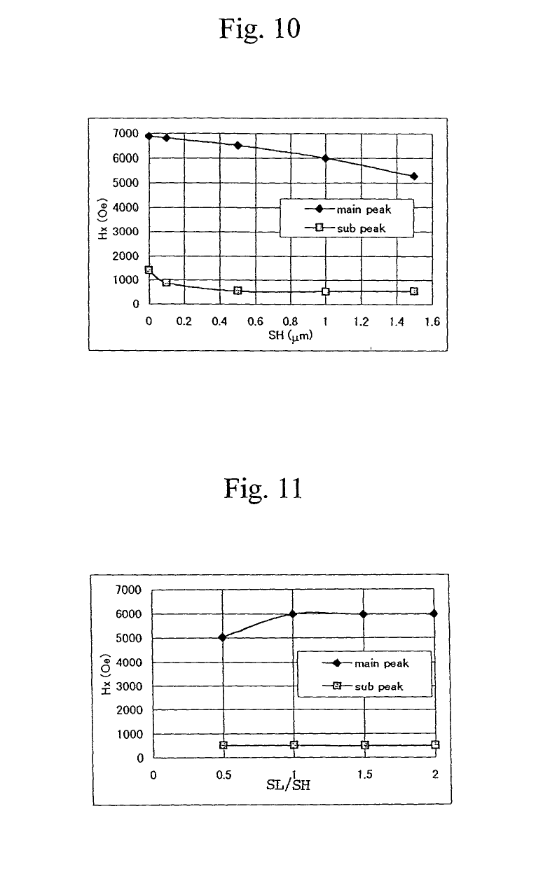

FIG. 10 is a graph showing the evaluation results of main peaks and sub peaks of the recording magnetic field Hx when the receding height SH is varied with regard to the thin film magnetic head of the present embodiment. In the illustrated example, there are shown “main peak” data (curve shown by ♦) and “sub peak” data (curve shown by □) of the recording magnetic field Hx when the receding height SH is varied in a rage of 0 to 1.6 μm.

First, with regard to the “main peak” data, it is appreciated that the recording magnetic field Hx is 6000 [Oe] or more in a range where the receding height SH is 1.0 μm or less, and that a sufficient overwrite characteristic is obtained. On the other hand, with regard to the “sub peak” data, the recording magnetic field Hx is 1500 [Oe] or less in the full range of the receding height SH, especially in a range where the receding height SH is 0.1 μm or more, the recording magnetic field Hx is 1000 [Oe] or less, and there is no intense magnetic field present except in the objective track. Such a state is sometimes expressed as “a good off-track profile is obtained”. In addition, the “main peak” data exceed the “sub peak” data in the full range of the receding height SH.

From the above, it proved that a sufficient overwrite characteristic was obtained and a good off-track profile was obtained when the receding height SH was 0.1 to 1.0 μm.

FIG. 11 is a graph showing the evaluation results of main peaks and sub peaks of the recording magnetic field Hx when a ratio (SL/SH) of the tip sub-magnetic pole length SL to the receding height SH is varied with regard to the thin film magnetic head of the present embodiment. In the illustrated example, there are shown the “main peak” data (curve shown by ▴) and the “sub peak” data (curve shown by □) of the recording magnetic field Hx when the ratio SL/SH is varied in a rage of 0 to 2.0 μm.

First, with regard to the “main peak” data, it is appreciated that the recording magnetic field Hx is 6000 [Oe] or more in a range where the ratio SL/SH is 1.0 or more, and that a sufficient overwrite characteristic is obtained. On the other hand, with regard to the “sub peak” data, the recording magnetic field Hx is 1000 [Oe] or less in the full range of the ratio SL/SH, and there is no intense magnetic field present except in the objective track. In addition, the “main peak” data exceed the “sub peak” data in the full range of the ratio SL/SH.

From the above, it proved that a sufficient overwrite characteristic was obtained and a good off-track profile was obtained when the ratio SL/SH was 0.1 or more.

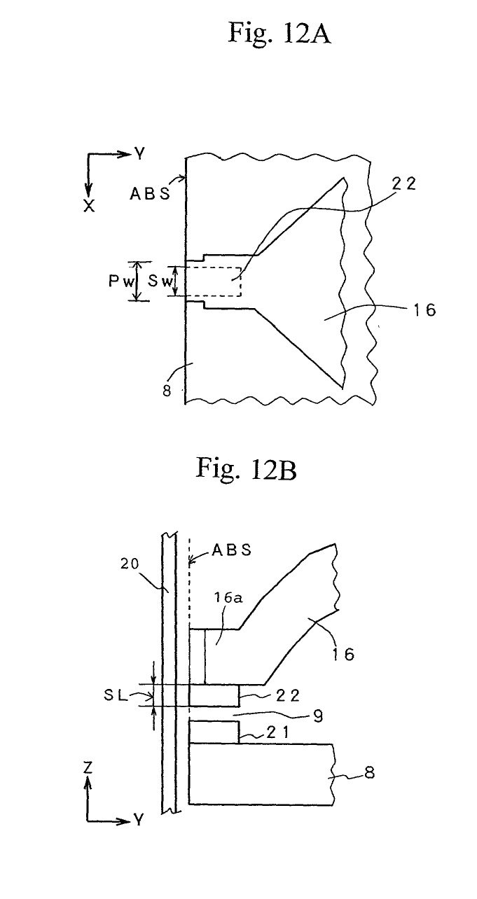

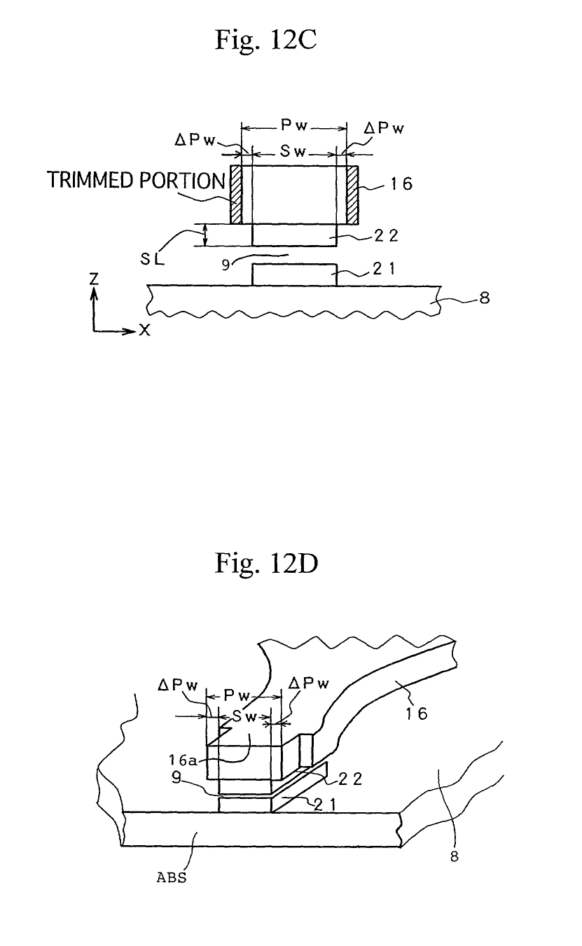

FIG. 12A to FIG. 12D show a constitution of the thin film magnetic head with a tip sub-magnetic pole according to the second embodiment of the present invention. The respective drawings show constitutions corresponding to FIG. 9A to FIG. 9D.

In this embodiment, evaluation was performed with regard to the trimming for the pole 16a of the upper magnetic pole 16.

As shown in FIG. 12B and FIG. 12D, a portion of the pole 16a in the vicinity of the floating surface ABS is formed to be more slender than the other portion. The formation is performed by trimming as shown in FIG. 12C. In order to specify the forming amount, ½ of a difference between the core width Pw of the upper magnetic pole 16 (pole 16a) and the core width Sw of the upper tip sub-magnetic pole 22 is defined as ΔPw. Specifically, an equation: ΔPw=(Pw−Sw)/2 is established. The ΔPw will be defined as a “core width difference” hereinbelow.

Note that the constitution of the thin film magnetic head according to this embodiment is basically the same as the constitution of the thin film magnetic head shown in FIG. 5A to FIG. 5C, except that the core width difference ΔPw is provided as described above.

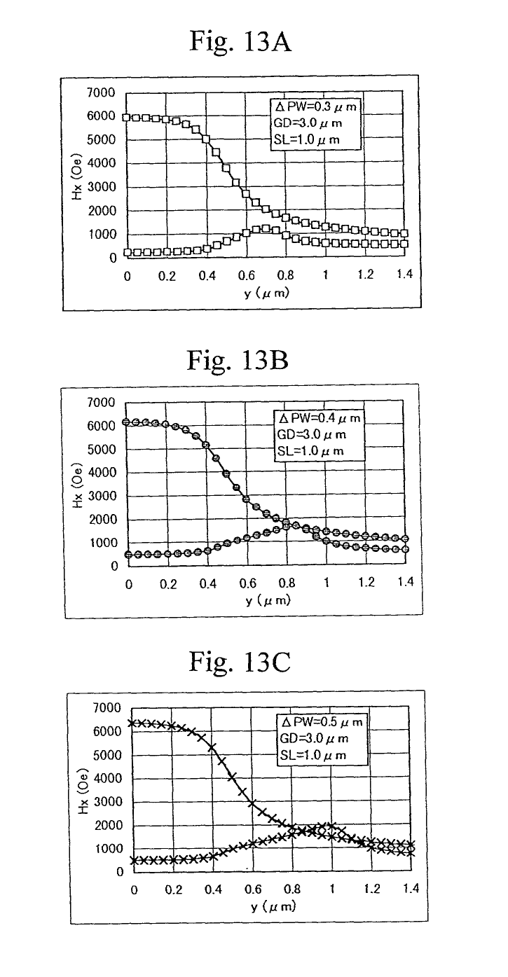

FIG. 13A to FIG. 13C are graphs showing evaluation results of the recording magnetic field Hx when the core width difference ΔPw is varied with regard to the thin film magnetic head of the present embodiment, and as conditions, a gap depth: Gd=3.0 μm, and the tip sub-magnetic pole length: SL=1.0 μm are set. FIG. 13A, FIG. 13B and FIG. 13C show the data of the recording magnetic field Hx when the core width difference ΔPw is 0.3 μm, 0.4 μm and 0.5 μm, respectively, and in each drawing, the upper characteristic curve represents the “main peak” data, and the lower characteristic curve represents the “sub peak” data.

First, when the core width difference ΔPw is 0.3 μm as shown in FIG. 13A, it is appreciated that, with regard to the “main peak” data, 6000 [Oe] of the recording magnetic field Hx is secured in the vicinity of y=0, and that a sufficient overwrite characteristic is obtained. On the other hand, with regard to the “sub peak” data, the recording magnetic field Hx is 1500 [Oe] or less in the full range of y=0 to 1.4 μm, and there is no intense magnetic field present except in the objective track. In addition, the “main peak” data exceed the “sub peak” data in the full range of y=0 to 1.4 μm. Similarly, also when the core width difference ΔPw is 0.4 μm as shown in FIG. 13B, with regard to the “main peak” data, 6000 [Oe] of the recording magnetic field Hx is secured in the vicinity of y=0, and with regard to the “sub peak” data, the recording magnetic field Hx is about 1500 [Oe] at maximum in the full range of y=0 to 1.4 μm, and further, the “main peak” data exceed the “sub peak” data in the full range of y=0 to 1.4 μm.

However, when the core width difference ΔPw is 0.5 μm as shown in FIG. 13C, with regard to the “main peak” data, 6000 [Oe] of the recording magnetic field Hx is secured in the vicinity of y=0, but with regard to the “sub peak” data, the recording magnetic field Hx exceeds 1500 [Oe] in the vicinity of y=1.0 μm, and in addition to this, the “sub peak” data exceed the “main peak” data in this vicinity.

From the above, it proved that a sufficient overwrite characteristic was obtained and a good off-track profile was obtained when the core width difference ΔPw is 0.4 μm or less.

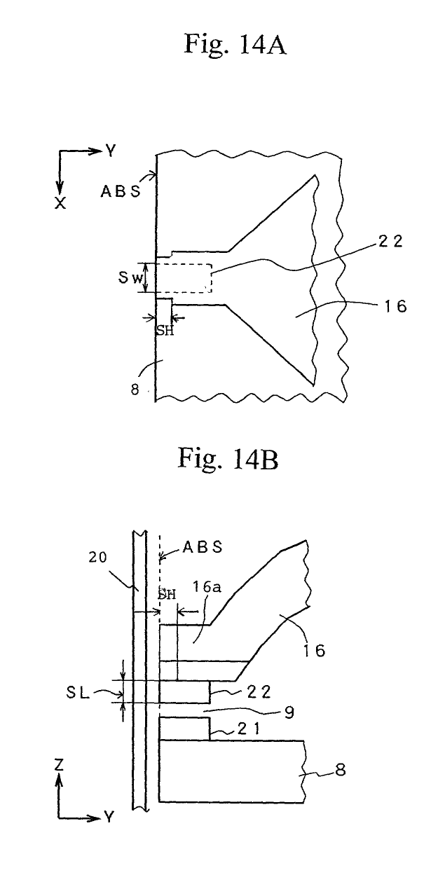

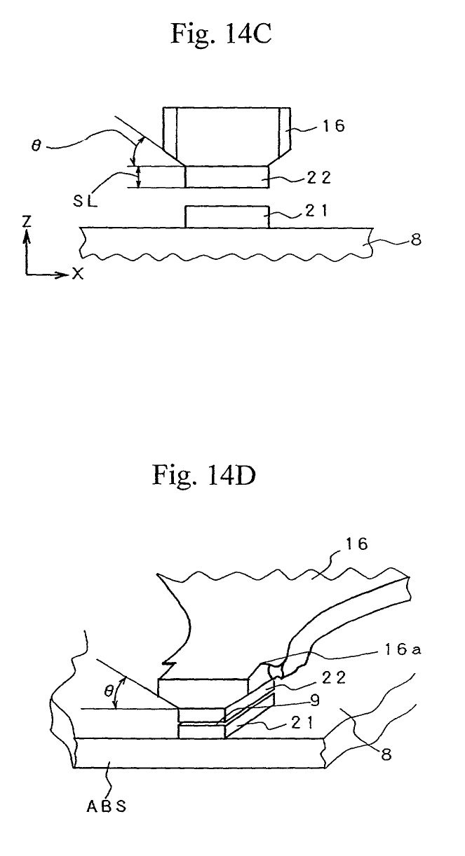

FIG. 14A to FIG. 14D show a constitution of the thin film magnetic head with a tip sub-magnetic pole according to the third embodiment of the present invention. The respective drawings show the constitutions corresponding to FIG. 9A to FIG. 9D.

In this embodiment, evaluation was performed with regard to chamfering the sharp upper magnetic pole edge (portion denoted by a reference numeral 16c in FIG. 9D) in order to reduce the magnetic field intensity of the sub peak.

As shown in FIG. 14C and FIG. 14D, in the pole 16a of the upper magnetic pole 16, both corner portions at the side of the lower magnetic pole are formed in a tapered shape at a specified angle θ. The angle θ will be defined as an “upper magnetic pole edge angle” hereinbelow.

Note that the constitution of the thin film magnetic head according to this embodiment is basically the same as the constitution of the thin film magnetic head shown in FIG. 5A to FIG. 5C, except that the upper magnetic pole angle θ is provided as described above.

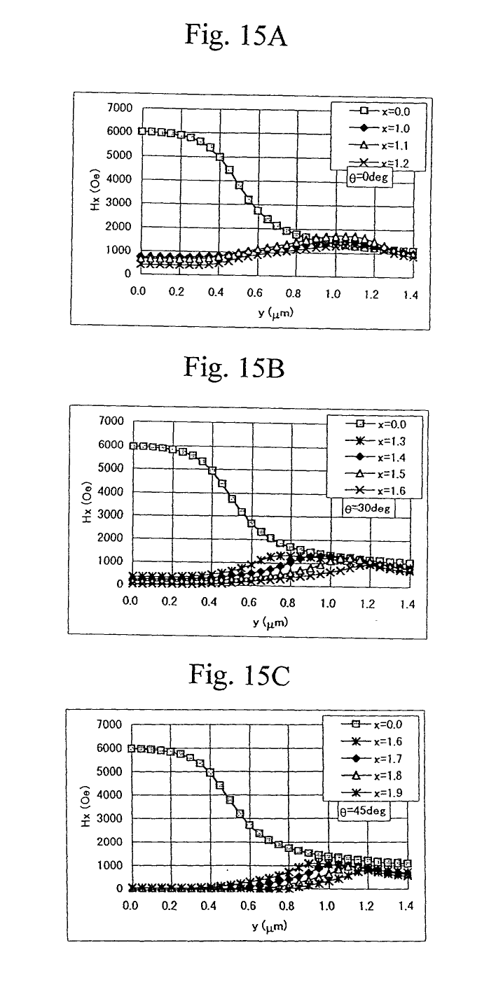

FIG. 15A to FIG. 15C are graphs showing evaluation results of the recording magnetic field Hx when the upper magnetic pole edge angle θ is varied with regard to the thin film magnetic head of the present embodiment. FIG. 15A, FIG. 15B and FIG. 15C show the data of the recording magnetic field Hx when the upper magnetic pole edge angle θ is 0° (namely, when chamfering is not performed), 30° and 45°, respectively.

In the characteristic curves shown in each drawing, as described in association with FIG. 8, x=0 (curve shown by □) represents the main peak, and a curve of x=1.1 μm represents an approximate center of the sub peak. Accordingly, as shown in FIG. 15A, x=1.0 μm (curve shown by ▴), x=1.1 μm (curve shown by Δ), and x=1.2 μm (curve shown by ×) represent the data of the approximate center of the sub peak and in the range plus and minus 0.1 μm (±0.1 μm) of the center of the sub peak. Moreover, in FIG. 15B, evaluation was performed for x=1.3 μm (curve shown by *), x=1.4 μm (curve shown by ▴), x=1.5 μm (curve shown by Δ) and x=1.6 μm (curve shown by *). Furthermore, in FIG. 15C, evaluation was performed for x=1.6 μm (curve shown by *), x=1.7 μm (curve shown by *), x=1.8 μm (curve shown by Δ) and x=1.9 μm (curve shown by *). The reason why such evaluation was performed is that, since the tip portion on which the magnetic charge is converged recedes when chamfering is performed at the upper magnetic pole edge angle θ(=30° or 45°) in order to eliminate the upper magnetic pole edge 16c, a spot high in the sub peak is sought in correspondence with such receding.

When the upper magnetic pole edge angle θ is 0°, as shown in FIG. 15A, namely, when chamfering is not performed, 6000 [Oe] of the recording magnetic field Hx is secured in the vicinity of y=0 with regard to the “main peak” data, but with regard to the “sub peak” data, the recording magnetic field Hx partially exceeds 1500 [Oe], and in addition, the “sub peak” data partially exceed the “main peak” data.

Contrary to this, when the upper magnetic pole edge angle θ is 30° as shown in FIG. 15B, 6000 [Oe] of the recording magnetic field Hx is secured in the vicinity of y=0 with regard to the “main peak” data, and with regard to the “sub peak” data, the recording magnetic field Hx is about 1500 [Oe] at maximum in the full range of y=0 to 1.4 μm, and further, the “sub peak” data do not exceed the “main peak” data in the full range of y=0 to 1.4 μm, either. Similarly, when the upper magnetic pole edge angle θ is 45° as shown in FIG. 15C, 6000 [Oe] of the recording magnetic field Hx is secured in the vicinity of y=0 with regard to the “main peak” data, and with regard to the “sub peak” data, the recording magnetic field Hx is 1500 [Oe] or less in the full range of y=0 to 1.4 μm, and further, the “sub peak” data do not exceed the “main peak” data in the full range of y=0 to 1.4 μm, either.

From the above, it proved that a sufficient overwrite characteristic was obtained and a good off-track profile was obtained when the upper magnetic pole edge angle θ was 30° or more.

As described above, the evaluation results according to the first to third embodiments are summarized as follows. (A) The first embodiment is characterized in that the upper magnetic pole edge 16c is moved away from the recording medium 20 (namely, the receding height SH is provided) in order to reduce the influence by the magnetic charge converged on the upper magnetic pole edge 16c, and it is advantageous that the receding height SH is set in the range of 0.1 to 1.0 μm.

Moreover, it is advantageous that the ratio (SL/SH) of the upper tip sub-magnetic pole to the receding height SH is set to be 1.0 or more.

(B) The second embodiment is characterized in that trimming is performed for the pole 16a of the upper magnetic pole 16 (namely, the core width difference ΔPw is provided), and it is advantageous that the core width difference ΔPw is set to be 0.4 μm or less.

(C) The third embodiment is characterized in that, in order to reduce the magnetic field intensity of the sub peak, the sharp portion of the upper magnetic pole is chamfered (namely, the upper magnetic pole edge angle θ is provided), and it is advantageous that the upper magnetic pole edge angle θ is set to be 30° or more.

\mathring{2} Manufacturing Method

Thin Film Magnetic Head with Tip Sub-magnetic Pole

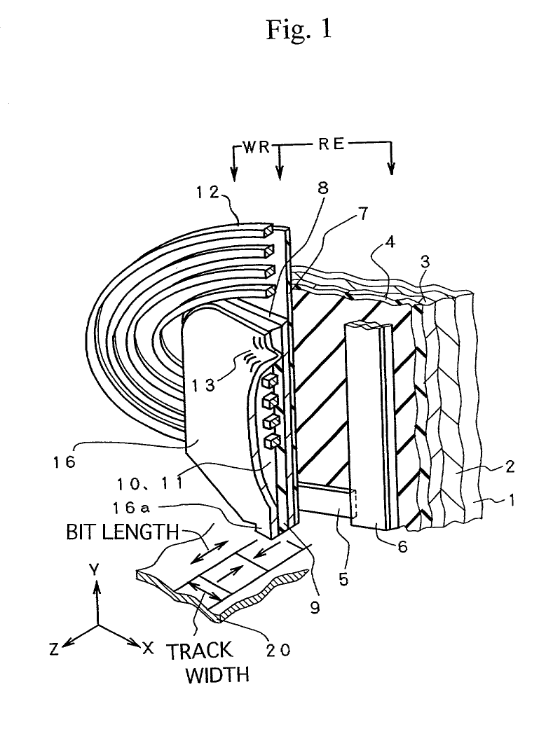

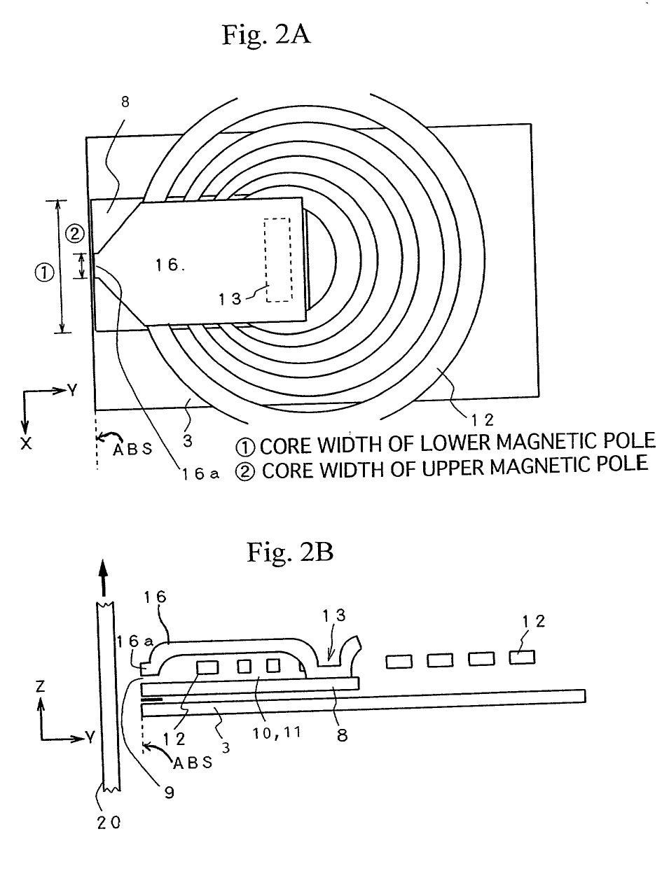

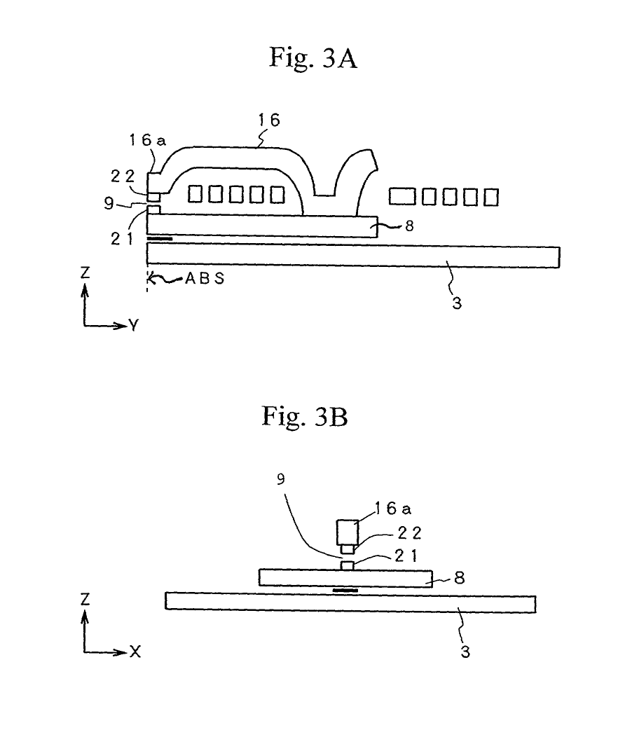

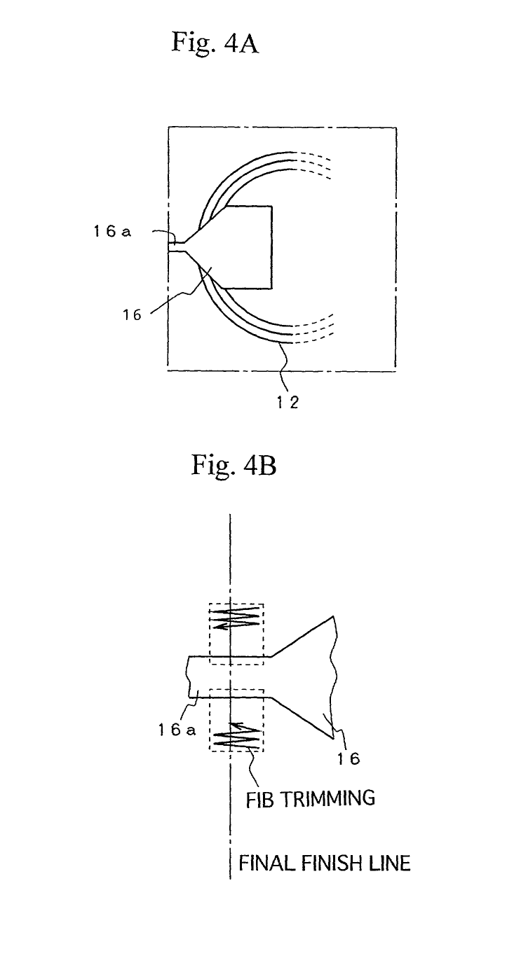

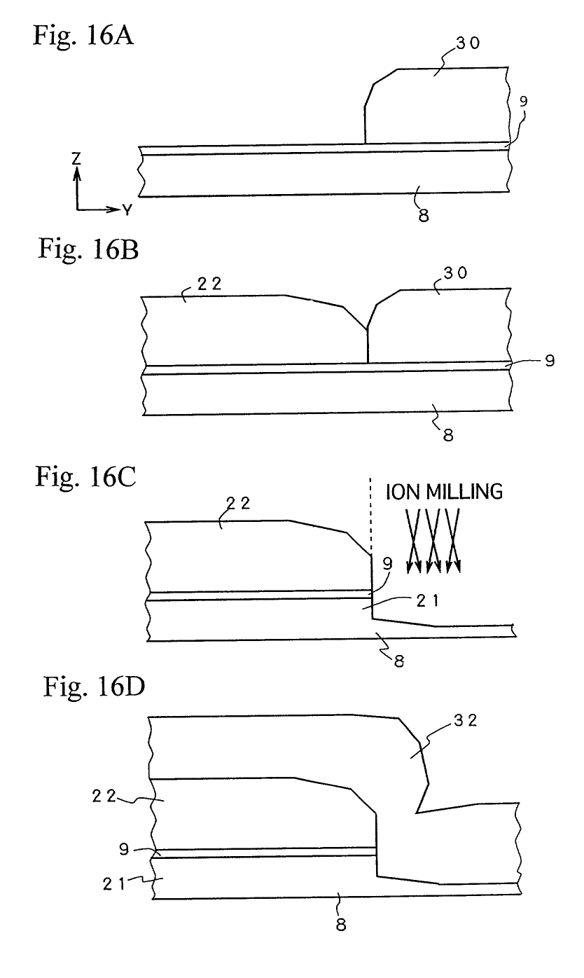

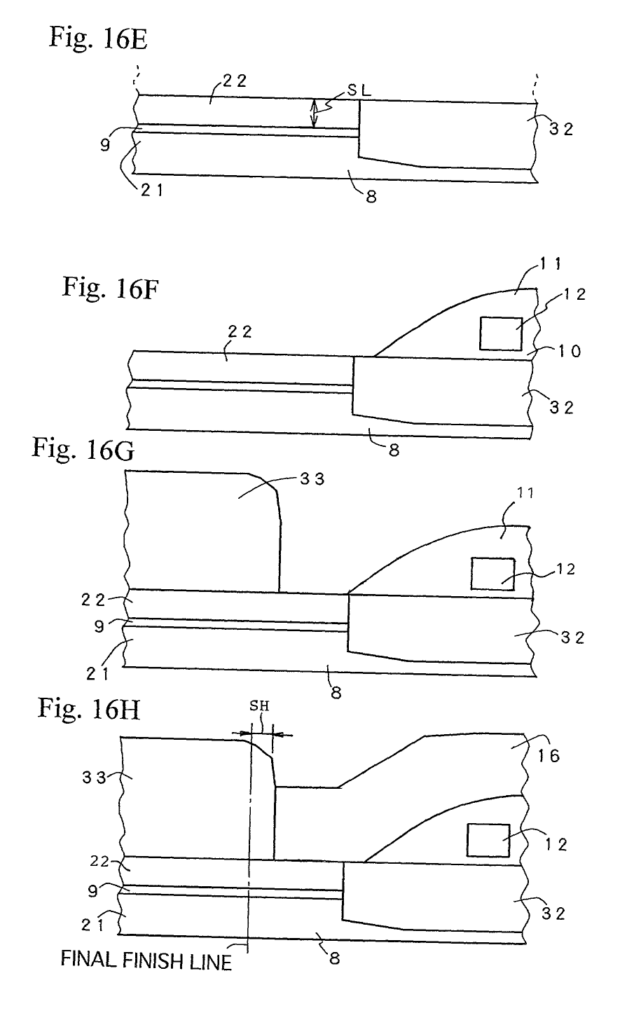

FIG. 16A to FIG. 16H are views showing a method of manufacturing the thin film magnetic head according to the first embodiment of the present invention in accordance with the order of processes. These drawings show a sectional structure corresponding to FIG. 9B. Note that, description will be made on the assumption that the reproducing head RE described in association with FIG. 1 has already been formed.

First, in the first step (see FIG. 16A), on the second non-magnetic insulating layer 7 (see FIG. 1) of the reproducing head RE, the lower magnetic pole 8 of the recording head WR, which is combined with the upper magnetic shield layer 8, is formed. The lower magnetic pole 8 typically consists of an NiFe-series alloy or a Co-series alloy, and for example, may be Ni(50)Fe(50), Ni(80)Fe(20), CoNiFe, FeZrN or the like. In advance, a plating base layer (not shown) is formed by a sputtering method or an evaporation method, and next, the lower magnetic pole 8 having a thickness of about several μm is formed by electrolytic plating. In the case where the lower magnetic pole 8 is deposited by the sputtering method, an Fe-series alloy or a Co-series alloy (CoZr or the like) is used. In this case, the plating base layer is not required.

Next, the recording gap layer 9 is formed on the lower magnetic pole 8. The recording gap layer 9 consists of, for example Al2O3, SiO2 or the like. In order to prevent the film thickness of the recording gap layer 9 from being reduced in a later etching step, a protective layer (not shown) may be provided on the recording gap layer 9 according to needs.

Next, on the recording gap layer 9, for example, a photosensitive photoresist 30 is coated by a spin coating method, and this resist 30 is patterned into a shape in accordance with the shape of the tip sub-magnetic pole formed in a later step.

In the next step (see FIG. 16B), the upper tip sub-magnetic pole 22 is formed with the resist 30 as a mask. Typically, this upper tip sub-magnetic pole 22 may be formed of the same material as that of the lower magnetic pole 8. In advance, a plating base layer (not shown) is formed by a sputtering method or an evaporation method, and next, the upper tip sub-magnetic pole 22 is formed by electrolytic plating. In the case where the upper tip sub-magnetic pole 22 is deposited by the sputtering method, Fe-series alloy or the Co-series alloy (CoZr or the like) is used. In this case, the plating base layer is not required. After forming the upper tip sub-magnetic pole 22, the resist 30 is removed.

In the next step (see FIG. 16C), one end of the upper tip sub-magnetic pole 22 is regulated based on a gap depth (see FIG. 9B), and the recording gap layer 9 and the lower magnetic pole 8 in a region other than a portion where this tip sub-magnetic pole 22 is formed are trimmed by ion milling. Thus, a portion remaining in a projection shape in the lower magnetic pole 8 constitutes the lower tip sub-magnetic pole 21.

In the next step (see FIG. 16D), the alumina layer 32 is formed so as to cover the upper tip sub-magnetic pole 22 and the exposed lower magnetic pole 8.

In the next step (see FIG. 16E), the surfaces of the alumina layer 32 and the upper tip sub-magnetic pole 22 are polished by lapping, polishing or the like and are flattened. The purpose of performing such flattening is to secure the position alignment accuracy at the time of coating of a resist in a later step by eliminating unevenness on the substrate, and thus to achieve the accuracy improvement in patterning the upper magnetic pole or the like. At this step, the length of the upper tip sub-magnetic pole 22 (tip sub-magnetic pole length) SL is defined.

In the next step (see FIG. 16F), on the alumina layer 32, the recording coil 12 surrounded by the non-magnetic insulating layers 10 and 11 is formed. This step will be briefly described because it is not directly associated with the present invention. First, a photoresist is coated, patterned appropriately, and thermally set, thus forming the insulating layer 10 under the recording coil 12. Thereafter, the spiral recording coil 12 is formed, and further, through coating of a photoresist, patterning, thermosetting or the like, the insulating layer 11 is formed around and on the recording coil 12. At this time, a portion corresponding to the center region of the spiral recording coil 12 (portion shown by a reference numeral 13 in FIG. 1) is removed, thus forming a hole. This hole is one for connecting the upper magnetic pole 16 with the lower magnetic pole 8 therethrough when the upper magnetic pole 16 is formed in a later step.

In the next step (see FIG. 16G), a plating base layer (not shown) is formed on the upper tip sub-magnetic pole 22 and the non-magnetic insulating layer 11, and further, the photosensitive photoresist 33 is coated thereon by a spin coating method, and the resist 33 is patterned into a shape in accordance with the shape of the upper magnetic pole formed in a later step.

In the final step (see FIG. 16H), the upper magnetic pole 16 is formed to have a thickness of several μm by electrical plating on the non-magnetic insulating layer 11 and the upper tip sub-magnetic pole 22 with the resist 33 as a mask. Further, after removing the resist 33, the exposed plating base layer other than that under the upper magnetic pole 16 is removed by ion milling. Thereafter, electrode pads (not shown) connected to terminals at the both ends of the magnetic transducer 5 and electrode pads (not shown) of the recording coil 12 are formed.

Finally, individual magnetic heads are cut out from the wafer where the plurality of magnetic heads are simultaneously formed, and the respective magnetic heads are mechanically polished from the floating surface ABS to a final finish line. The final finish line is determined by the gap depth Gd (see FIG. 9B), and at this step, the “receding height SH” of the upper magnetic pole 16 is defined.

By the steps described above in FIG. 16A to FIG. 16H, the thin film magnetic head with the tip sub-magnetic pole having the unique shape according to the first embodiment can be manufactured.

Formation of Upper Magnetic Pole

For the thin film magnetic head manufactured by the steps of FIG. 16A to FIG. 16H, the pole 16a of the upper magnetic pole 16 is trimmed to be formed in a desired shape according to needs, thus enabling a further improvement in the characteristic to be achieved. Then, appropriate trimming is executed for the pole 16a, and thus the “core width difference ΔPw” according to the second embodiment and the “upper magnetic pole edge angle θ” according to the third embodiment are defined.

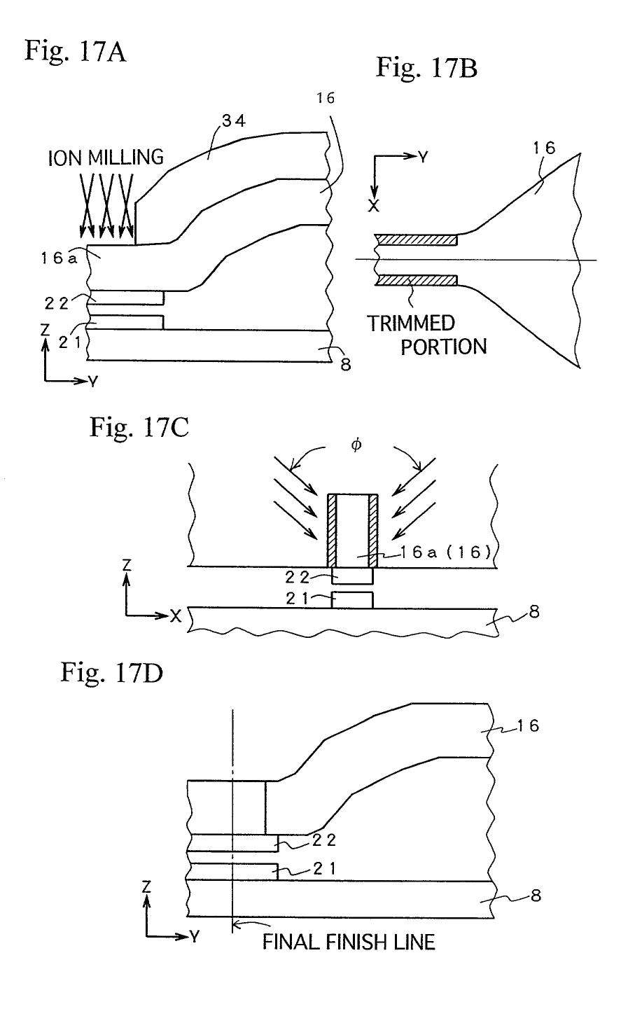

FIG. 17A to FIG. 17D show a manufacturing process in the case where trimming by ion milling is performed for the wafer surface. First, as shown in FIG. 17A and FIG. 17B, after forming up to the upper magnetic pole 16 on the substrate (wafer), the protective film 34 or a protective resist patterned so as to open an window only in the vicinity of a trailing edge of the upper magnetic pole 16 is coated, and trimmed by ion milling. As shown in FIG. 17C, the ion milling is one in which the wafer is rocked at a specified angle (φ) while rotating it, and is subjected to a polishing processing from the floating surface side. By this method, the side surfaces of the upper magnetic pole 16 can be polished to a desired extent without scraping the upper surface thereof so much. Then, as shown in FIG. 17D, after removing the protective film 34, the individual thin film magnetic heads are cut out from the wafer, and are subjected to the polishing processing from the floating surface to the final finish line.

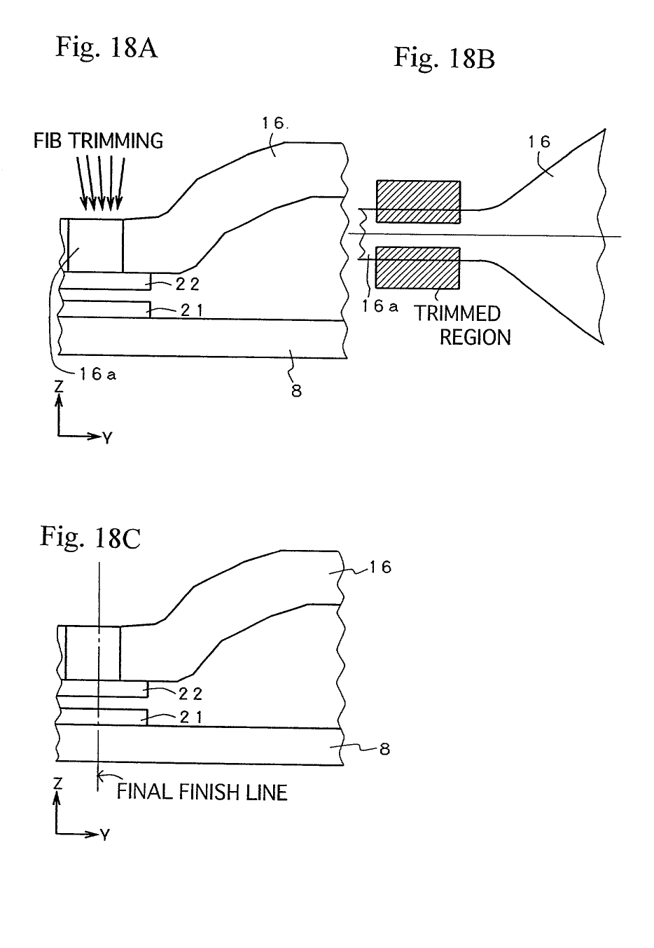

FIG. 18A to FIG. 18C show a manufacturing process in the case where the FIB trimming is performed for the wafer surface. First, as shown in FIG. 18A and FIG. 18B, after forming up to the upper magnetic pole 16 on the substrate (wafer), the trimming by the focused ion beam (FIB) focused on the vicinity of the trailing edge of the upper magnetic pole 16 is performed. Then, as shown in FIG. 18C, the individual thin film magnetic heads are cut out from the wafer, and are subjected to the polishing processing from the floating surface to the final finish line.

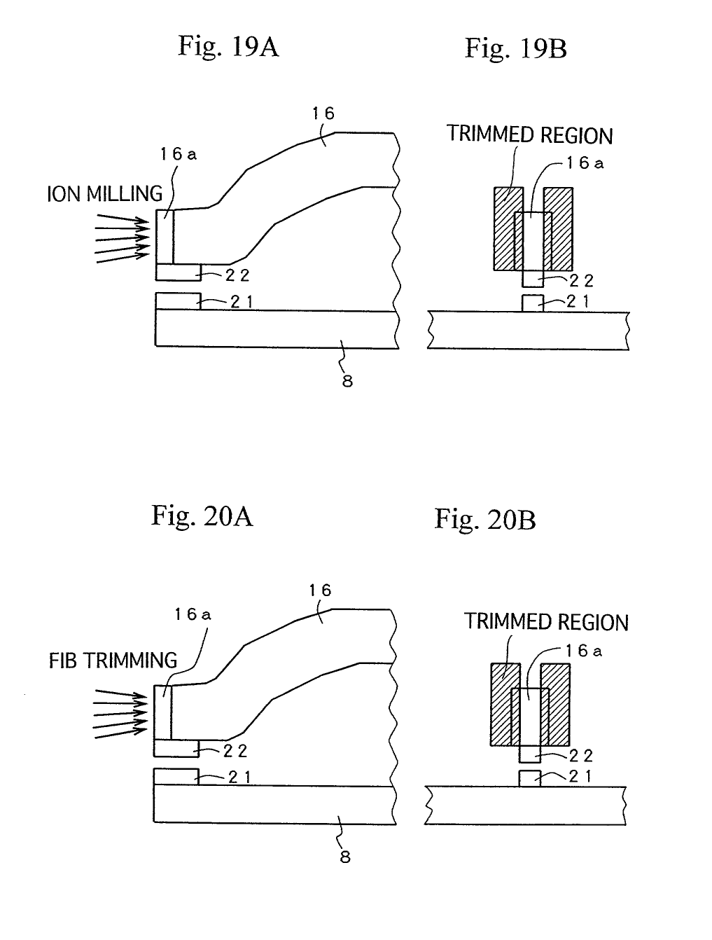

FIG. 19A and FIG. 19B show a manufacturing process in the case where the trimming by ion milling is performed for the floating surface. As shown in the drawings, after cutting out each magnetic head from the wafer and performing the polishing processing therefor from the floating surface (namely, after performing a slider processing therefor), on the floating surface, a protective film or the like (not shown) patterned so as to open an window only in the vicinity of a side edge of the upper magnetic pole 16 is coated, and trimmed by ion milling.

FIG. 20A and FIG. 20B show a manufacturing process in the case where the FIB trimming is performed for the floating surface. As shown in the drawings, after cutting out each magnetic head from the wafer and performing the polishing processing therefor from the floating surface (namely, after performing the slider processing therefor), the trimming by the FIB focused on the side edge portion of the upper magnetic pole 16 is performed on the floating surface.

As described above, according to the thin film magnetic head and the method of manufacturing the same according to the present invention, the shapes, the positional relations or the like of the upper magnetic pole and the upper tip sub-magnetic pole of the thin film magnetic head are optimized, thus the existence of the sub peak can be substantially eliminated, and both the improvement in the recording blur characteristic and the good overwrite characteristic can be realized. Concretely, as shown in the first to third embodiments, the end portion at the side of the floating surface ABS of the upper magnetic pole 16 is made to recede from the end portion at the side of the floating surface ABS of the upper tip sub-magnetic pole 22, alternatively the trimming for the pole 16a of the upper magnetic pole 16 is performed, alternatively the sharp portion of the upper magnetic pole is chamfered, thus making it possible to reduce the influence by the magnetic charge converged on the upper magnetic pole edge, and to reduce the magnetic field intensity of the sub peak.

1. A thin film magnetic head, comprising:
a lower magnetic pole (8);
an upper magnetic pole (16) disposed to face said lower magnetic pole;
a recording coil (12) disposed between said lower magnetic pole and said upper magnetic pole, the recording coil being spaced from said both magnetic poles; and
an upper tip sub-magnetic pole (22) provided at the side of said lower magnetic pole of said upper magnetic pole in the vicinity of a floating surface,
said upper magnetic pole and said upper tip sub-magnetic pole being disposed in such a manner that an end portion at the side of a floating surface of said upper magnetic pole recedes from an end portion at the side of the floating surface of said upper tip sub-magnetic pole.

2. The thin film magnetic head according to claim 1, wherein, when a distance between the end portion at the side of the floating surface of said upper magnetic pole and the end portion at the side of the floating surface of said upper tip sub-magnetic pole is defined as a receding height (SH) of said upper magnetic pole, the receding height of said upper magnetic pole is selected to be a value at which at least one of an overwrite characteristic and an off-track profile is improved.

3. The thin film magnetic head according to claim 2, wherein the receding height of said upper magnetic pole is selected to be within a range from 0.1 μm to 1.0 μm.

4. The thin film magnetic head according to claim 1, wherein, when a receding distance between the end portion at the side of the floating surface of said upper magnetic pole and the end portion at the side of the floating surface of said upper tip sub-magnetic pole is defined as a receding height (SH) of said upper magnetic pole, and a film thickness of said upper tip sub-magnetic pole is defined as a tip sub-magnetic pole length (SL), a ratio (SL/SH) of said tip sub-magnetic pole length to the receding height of said upper magnetic pole is selected to be a value at which at least one of an overwrite characteristic and an off-track profile is improved.

5. The thin film magnetic head according to claim 4, wherein the ratio of said tip sub-magnetic pole length to the receding height of said upper magnetic pole is selected to be 1.0 or more.

6. The thin film magnetic head according to claim 1, further comprising a lower tip sub-magnetic pole (21) provided at the side of said upper magnetic pole of said lower magnetic pole in the vicinity of the floating surface, the lower tip sub-magnetic pole having the same shape as that of said upper tip sub-magnetic pole.

7. The thin film magnetic head according to claim 1, wherein said upper magnetic pole is formed in a tapered shape in such a manner that both corner portions at the side of said lower magnetic pole of a pole (16a) thereof are chamfered.

8. A complex magnetic head comprising:
a recording head using the thin film magnetic head according to claim 1; and
a reproducing head using a magnetoresistance effect element as a magnetic transducer,
said recording head and said reproducing head being integrally formed.

9. A thin film magnetic head, comprising:
a lower magnetic pole (8);
an upper magnetic pole (16) disposed to face said lower magnetic pole;
a recording coil (12) disposed between said lower magnetic pole and said upper magnetic pole, the recording coil being spaced from said both magnetic poles; and
an upper tip sub-magnetic pole (22) provided at the side of said lower magnetic pole of said upper magnetic pole in the vicinity of a floating surface,
said upper magnetic pole being formed in such a manner that a portion of a pole (16a) thereof in the vicinity of the floating surface is narrower than the other portion of the pole, and is wider than a core width of said upper tip sub-magnetic pole.

10. The thin film magnetic head according to claim 9, wherein, when ½ of a difference between a core width (Pw) of the portion of said pole in the vicinity of the floating surface and the core width (Sw) of said upper tip sub-magnetic pole is defined as a core width difference (ΔPw), said core width difference is selected to be a value at which at least one of an overwrite characteristic and an off-track profile is improved.

11. The thin film magnetic head according to claim 10, wherein said core width difference is selected to be 0.4 μm or less.

12. The thin film magnetic head according to claim 9, further comprising: a lower tip sub-magnetic pole (21) provided at the side of said upper magnetic pole of said lower magnetic pole in the vicinity of the floating surface, the lower tip sub-magnetic pole having the same shape as that of said upper tip sub-magnetic pole.

13. The thin film magnetic head according to claim 9, wherein said upper magnetic pole is formed in a tapered shape in such a manner that both corner portions at the side of said lower magnetic pole of the pole (16a) thereof are chamfered.

14. A complex magnetic head comprising:
a recording head using the thin film magnetic head according to claim 9; and
a reproducing head using a magnetoresistance effect element as a magnetic transducer,
said recording head and said reproducing head being integrally formed.

15. A method of manufacturing a thin film magnetic head, comprising the steps of:
(a) forming a lower magnetic pole (8);
(b) patterning a first resist (30) in a predetermined shape on said lower magnetic pole, so as to form an upper tip sub-magnetic pole (22) in accordance with a shape of the first resist;
(c) partially trimming said lower magnetic pole, after removing said first resist, so as to form a lower tip sub-magnetic pole (21);
(d) forming an alumina layer (32) on a trimmed portion of said lower magnetic pole and said upper tip sub-magnetic pole;
(e) polishing and flattening surfaces of said alumina layer and said upper tip sub-magnetic pole in a film thickness direction;
(f) forming a recording coil (12) with a periphery surrounded by non-magnetic insulating layers (10, 11) on said flattened alumina layer;
(g) patterning a second resist (33) in a predetermined shape on said flattened upper tip sub-magnetic pole, so as to form an upper magnetic pole (16) in accordance with a shape of the second resist; and
(h) cutting out a thin film magnetic head from a wafer, after removing said second resist, so as to mechanically polish the head to a final finish line.

16. The method according to claim 15, further comprising the step of forming a recording gap layer (9) on said lower magnetic pole after said step (a), wherein said first resist is coated on the formed recording gap layer.

17. The method according to claim 15, wherein said step (c) includes a step of partially trimming said lower magnetic pole by ion milling.

18. The method according to claim 15, further comprising the steps of: coating a protective film on a region other than a vicinity region that will be the floating surface of said upper magnetic pole, so as to pattern the film in a predetermined shape; and trimming the wafer surface by ion milling, after said step (h).

19. The method according to claim 15, further comprising the step of trimming the wafer surface by a focused ion beam, between said step (g) and said step (h).

20. The method according to claim 15, further comprising the steps of: coating a protective film on a region other than a vicinity region that will be the floating surface of said upper magnetic pole, so as to pattern the film in a predetermined shape; and trimming said floating surface by ion milling, after said step (h).

21. The method according to claim 15, further comprising the step of trimming the floating surface of said upper magnetic pole by a focused ion beam after said step (h).

22. The method according to claim 15, wherein, in said step(h), a distance between an end portion at the side of the floating surface of said upper magnetic pole and an end portion at the side of the floating surface of said upper tip sub-magnetic pole is defined as a receding height (SH) of said upper magnetic pole.

23. The method according to claim 15, further comprising the step of trimming a pole (16a) of said upper magnetic pole so as to form the same in a predetermined shape after said step (h), wherein ½ of a difference between a core width (Pw) of a portion of said pole in the vicinity of the floating surface and a core width (Sw) of said upper tip sub-magnetic pole is defined as a core width difference (ΔPw) by the forming step.

24. The method according to claim 15, further comprising the step of trimming a pole (16a) of said upper magnetic pole so as to form the same in a predetermined shape, after said step (h), wherein an angle at which both corner portions at said lower magnetic pole side of said pole are chamfered is defined as an upper magnetic pole edge angle (θ).
